(19) United States
(12) Patent Application Publication
(10) Pub. No.: US 2003/0071703 A1
(43) Pub. Date: Apr. 17, 2003

(54) Magnetic display apparatus

(76) Inventor: Ralph Machesky, Derry, NH (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/267,012

(22) Filed: Oct. 8, 2002

Related U.S. Application Data
(60) Provisional application No. 60/327,989, filed on Oct. 9, 2001.

(51) Int. Cl. H01H 9/00

(52) U.S. Cl. 335/205

(57) ABSTRACT

The present invention relates to a magnetic display apparatus having a first magnetic layer, a second layer having an outer surface and an inner surface, and an adhesive adapted to bond the inner surface of the second layer to the magnetic layer. The outer surface of the second layer preferably has marking-receptive properties and the inner surface preferably includes reverse-printed matter disposed thereon. The unit can be sold as a do-it-yourself kit to allow users to print on the second layer, and then adhere the second layer to the magnetic unit to form a magnetic display apparatus. In one embodiment, two separate magnetic units can be magnetically adhered to each other to form an object having an image and/or text displayed on each side thereof. In another embodiment, two units can be positioned on opposite sides of a plane, such as a page, to serve as a marker.

### REFERENCE TO RELATED APPLICATION

This application claims priority from U.S. Provisional Patent Application Serial No. 60/327,989, filed on Oct. 9, 2001, entitled “Magnetic Display Apparatus,” which is expressly incorporated by reference herein.

### BACKGROUND OF THE INVENTION

Magnets are well known and are commonly used to display images and text, or to mount articles to objects such as a refrigerator door. Recently, companies have began supplying their customers with magnetic business cards or other types of magnetic advertising materials. Customers can place the magnets on, for example, their refrigerators or file cabinets for display and/or for future access to information.

One common method of making magnetic display media is to print on a sheet of magnetic material using polyvinyl chloride (PVC) and a silk-screening process. Due to the time-consuming process, PVC printed magnetic materials are usually limited to a few color choices. Moreover, since vinyl is soft and porous, marking on the surface is susceptible to smearing, staining, and abrasion.

Other methods of making magnetic display media include the use of three or four layers: a magnetic backing layer, an article adhered to the magnetic backing, an adhesive layer, and a transparent outer protective layer. The layers can be sold as a unit, or can be sold separately to allow the users to create their own magnetic display unit. Common articles, such as pictures and business cards, can be used to create the magnetic display media. A business card, for example, is simply glued to the magnetic backing, and then the transparent outer layer can be disposed over the business card to protect the card from damage.

Magnetic display media is also provided in do-it-yourself kits. This allows the customer to print their own advertising, business cards, or other display materials and adhere them to a magnetic backing. These kits, however, usually require a transparent protective outer layer to prevent smearing of the ink. Some kits allow customers to print directly onto the magnetic surface, thereby eliminating the need for pre-printed materials. However, these kits are limited to use with ink jet printers, as the operating temperature of a laser printer can cause damage to the magnetic material. Moreover, the magnetic material is often too thick to feed through a laser printer. Thus, the print quality is often limited by the print quality of an ink jet printer. Do-it-yourself kits also tend to peel apart, as the adhesive properties wear over time.

Accordingly, there exists a need for magnetic display materials which provide superior display properties and adhesive properties. Moreover, there exists a need for do-it-yourself magnetic display kits which can be prepared using both ink jet and laser jet printers, as well as color copies, and which do not require an additional layer, such as a transparent protective outer layer.

### SUMMARY OF THE INVENTION

The present invention relates to a magnetic unit which can be easily prepared and which does not require pre-printed matter. The magnetic unit is particularly advantageous in that it enables reverse-printing, only requires one or two layers of material, and provides a waterproof unit having a marking-receptive surface and being less susceptible to wear and tear. The magnetic units are particularly useful for creating magnetic business cards, magnetic note pads, magnetic photographs, and other similar magnetic display media. In general, the magnetic display apparatus includes a first magnetic layer, a second layer having an outer surface and an inner surface, and an adhesive adapted to bond the inner surface of the second layer to the magnetic layer. The outer surface of the second layer preferably has marking-receptive properties and the inner surface preferably includes reverse-printed matter disposed thereon.

In one embodiment, a do-it-yourself kit is provided having a magnetic layer, a second transparent layer, and an adhesive for bonding the magnetic layer to the second transparent layer. The second layer includes an inner surface which can be reverse-printed on using any type of printer known in the art, including color copies, ink jet printers, and laser printers. The inner surface can be bonded to the magnetic layer using the adhesive to form a magnetic display unit. In one embodiment, two magnetic display units can be magnetically adhered to each other to create an apparatus having a display on one or both sides.

In another embodiment according to the present invention, a magnetic apparatus is provided having at least two units, each unit comprising an inner layer that has magnetic properties and an outer layer. In a preferred embodiment, the outer layer of each unit of the apparatus consists of a marking receptive surface. Two units can be positioned anywhere on opposed sides a plane, such as a page, to serve as a bookmark, Post-It Note or clip. The apparatus can serve as a two-part magnetic business card consisting of separable magnetic units.

One advantage of the present invention over the prior art is that offering the apparatus in kit form allows reverse printing on the inner side of the marking receptive surface prior to adhering it to the magnetic layer. The marking receptive surface can be placed into a laser or inkjet printer or copier apart from the magnetic layer. Offering the marking receptive surface separate from the magnetic layer overcomes the limitations set forth by the prior art regarding the thickness of the magnetic paper sheet. Offering the marking receptive surface separate from the magnetic layer also allows multiple marking receptive surfaces to be fed into a printer or copier without clinging to each other due to magnetic attraction. Moreover, the need for a third, pre-printed layer is eliminated.

### BRIEF DESCRIPTION OF THE DRAWINGS

The invention will be more fully understood from the following detailed description taken in conjunction with the accompanying drawings, in which:

FIG. 1 is an illustration of a magnetic unit according to one embodiment of the present invention;

FIG. 2 is a perspective view of two magnetic units magnetically adhered to each other according to another embodiment of the present invention;

FIG. 3 is a perspective view of two magnetic units having a portion magnetically adhered to each other and having another portion positioned on opposed sides of a substrate and magnetically adhered to each other across the substrate;

FIG. 4 is an illustration of a magnetic unit disposed on one side of a substrate and being magnetically adhered to another magnetic unit (not shown) disposed on an opposed side of the substrate; and

FIG. 5 is a perspective view of a first magnetic layer and a second layer having reverse printing thereon and adapted to be adhered to the magnetic layer to form a magnetic unit according to another embodiment of the present invention.

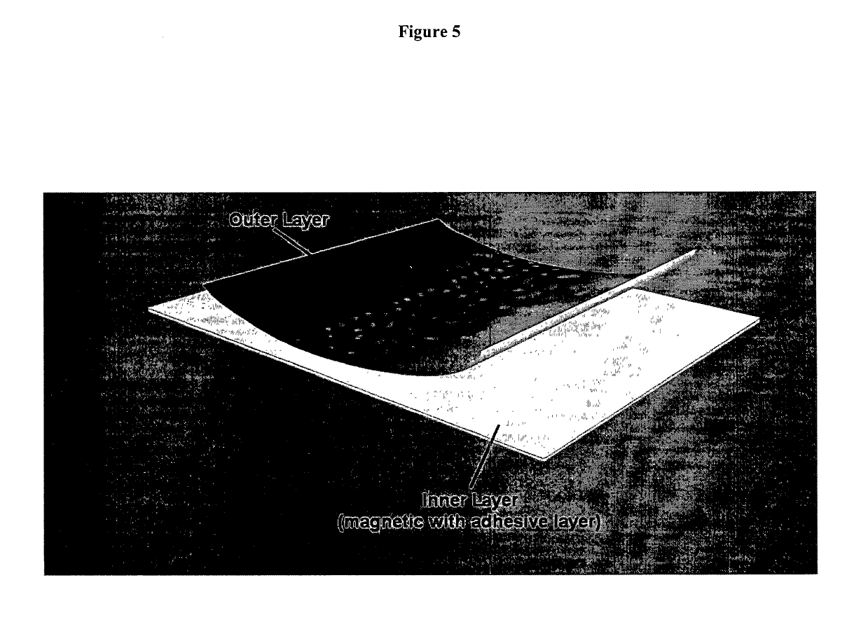

### DETAILED DESCRIPTION OF THE INVENTION

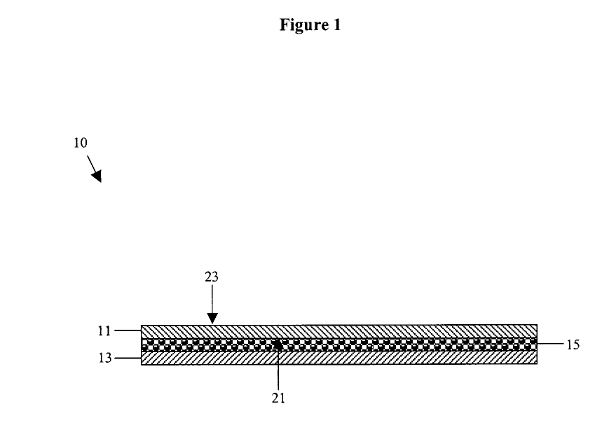

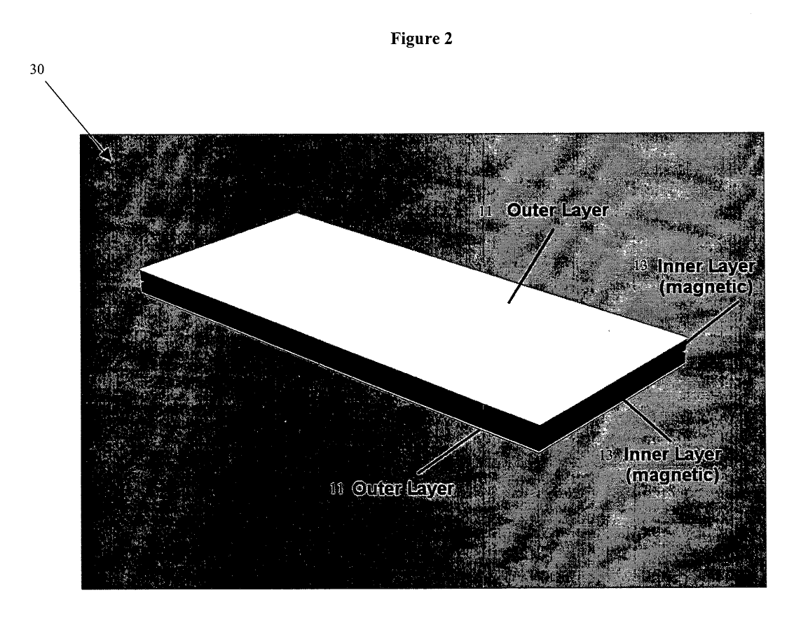

As shown in FIG. 1, the present invention provides a magnetic unit 10 that includes a first magnetic layer 13, a second layer 11 having an inner surface 21 and an outer surface 23, and an adhesive 15 disposed between the magnetic layer 13 and the inner surface 21 of the second layer 11 for bonding the layers together. The outer surface 23 of the second layer 11 preferably has marking-receptive properties which allows a user to mark on the surface thereof, and the inner surface 21 preferably includes reverse-printing disposed thereon. The present invention is particularly advantageous in that the layers can be sold as a kit, along with the adhesive. The second layer 11 can be printed on using any inkjet printer, laser printer, or color copier, and the layers can then be adhered together to form a single magnetic unit for displaying text and/or an image. In one embodiment, shown in FIG. 2, two separate magnetic units 10 can be magnetically adhered to each other to form an object 30 having an image and/or text displayed on each side thereof.

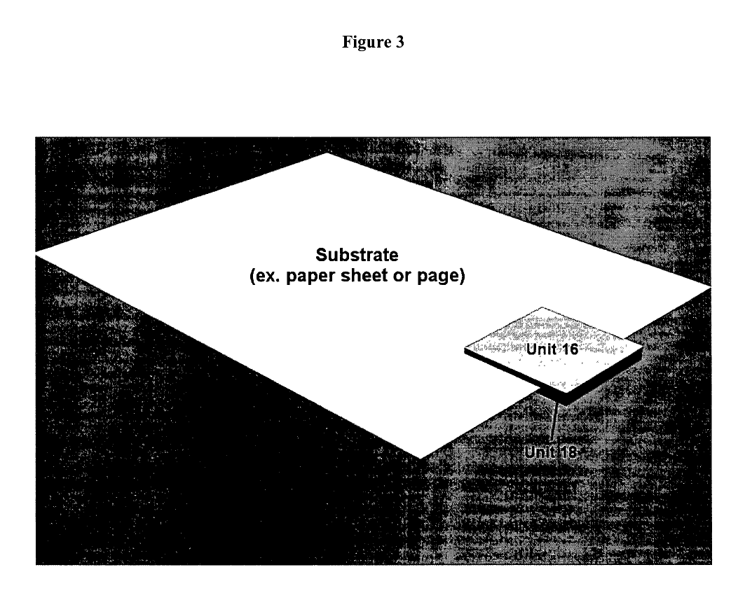

In another embodiment, as shown in FIG. 3, the apparatus generally includes a first magnetic unit 16 and a second magnetic unit 18. Each unit 16, 18 adheres to the other by magnetic attraction in a fixed position, including when each unit is positioned on opposite sides of a plane such as a page of a book. Each unit 16, 18 can be manually positioned at any location on a page to mark text or images on the page. For removal, the units 16, 18 of the apparatus can be separated and moved to another position.

Each unit 16, 18 of the apparatus includes an outer layer 10, preferably having a substance with marking receptive properties, adhered to an inner layer having magnetic properties 12. While the preferred embodiment's outer layer utilizes synthetic materials such as MYLAR, DURA-LAR, or LEXAN that are marking receptive surfaces, it should be noted that other materials can could be used as the outer layer.

A manufacturer can control the orientation of the magnetic particles (and thus the magnetic polarity) in the magnetic layer 12 such that the two units of the apparatus can attract each other and adhere together in a symmetrical fashion, or repel away from each other. Rows of magnetic particles in each unit of the apparatus are aligned, such that there is attraction or repulsion of units depending upon positioning of one unit with another. The magnetic layer 12 can be constructed with varying strength Gauss.

The disclosed apparatus overcomes the risk of damage of known flimsy paper bookmarks and POST-IT NOTES or other indicators caused by loss of adherence or damage caused by ordinary wear and usage, as paper is prone to crumpling or tearing.

Removable passcodes can be written on the marking receptive surface of a unit section 10 of the disclosed apparatus. For example, a transient identifier can be printed on the marking receptive surface 10 of a unit section in which the ink will “disappear”, lending itself to applications such as an inexpensive sentry identifier, parking lot position identifier or ticket for use as an admission ticket to a club. It is foreseeable that different types of ink could be used on a the marking receptive surface of each apparatus unit, including long lasting ink, transient lasting ink or set limited time-based ink printing. As another example, reverse printing on the inside of the outer layer of the apparatus can indicate a room number of a hotel.

The disclosed apparatus can be made of varying shapes and sizes. One embodiment, is that of a note-sized rectangular pad, a shape convenient for functioning as a tab as shown in FIG. 3 and of size suitable for paper tabbing and indexing for page file identification.

At least one side of the magnetic layer can be coated with a layer of color or other indicia. In such an embodiment, a transparent or opaque outer layer can be bonded to the colored side of the magnetic surface to provide for an apparatus of a particular color or design.

The apparatus can also serve as a book or magazine insert that is not easily dislodged as it includes two units 16, 18 that are held in place by mutual magnetic attraction. Further, the adherence of the apparatus would not affect underlying surfaces to which the apparatus is attached.

The shape of each unit 16, 18 can also be varied to form, for instance, a licensing advertiser's advertising logo such as the McDonalds™ logo.

The apparatus could be utilized as a book or magazine advertising insert which can, being cleanly removable, be placed in areas in which adhesive backed media cannot be used to advertise for clientele, without the disadvantage of the messy glue from traditional media's residue. Space on the outer layer of at least one of the unit 16, 18 of the apparatus can be licensed for coupon incentives, logos, or other consumer promotions. The apparatus can be used, for instance, as a transit ad, which can be placed on surfaces, without leaving adhesives on the surface to which it is adhering, for example on a magazine page. The durability, mobility and reusability of the apparatus units encourage people to keep and reuse them.

Printing reversed on the side of the outer layer 10 that is bonded to the magnetic layer is also possible for certain applications such as reverse printing of logos. Reverse printing on the side of the outer layer 10 that is bonded to the magnetic layer also allows, for example, a magnetic business card to be printed, which is distinct from known magnetic paper that only allows printing on the top side of the writing surface. Such a business card can further distinguished from existing magnetic business cards in that it can include at least two detachable magnetic units, with at least one of said units having an outer layer with marking receptive properties. A double-sided adhesive can seal the outer layer 10 containing the reverse printed matter to the magnetic layer 12. Such reverse printing protects the printed matter and provides durability. Reverse printing can be done, for example, on MYLAR sheets, as well as a polycarbonate coated with a printable coating. Reverse printing also allows for full color laser printing or multiple color off set color printing process to then seal within the outer layer 10 and magnetic layer 12.

In another embodiment, a double-sided commercial adhesive such as two-sided double tack adhesive can be used to bond the outer layer 10 to the magnetic layer 12. Or an adhesive layer sandwiched, laminated, or bonded between a magnetic sheet and an outer surface made from, for example, MYLAR™, nylon, DURA-LAR™, LEXAN™ polycarbonate or other synthetic material is also possible.

Manufacturing a unit of the apparatus can be via presses, machine or other means. An outer layer 10 can be adhered to a magnetic layer 12 via known sonic welding, which is a process of melting two thermal plastics to melt and cool, forming a bond between two surfaces such as 10, 12. Manufacturing an apparatus can also be via a known thermal setting process such as interleaving in which a heated magnetic material 12 is interwoven with the outer layer 10 and pressed together. Interleaving a heated magnetic layer 12 and an outer layer 10 can be achieved by rolling or squeezing the two layers together to form a bonded unit. Adhesive such as glue and rubber cement are possible bonding means in other embodiments. Pressure can be utilized as well to assemble the units of the apparatus.

While the current embodiment allows two units 16, 18 to act as one apparatus, it is foreseeable to use only a one unit of the apparatus. One such example would be that of an improved magnetic “White-Board.” A unit of the apparatus can be utilized as a magnetic white board which can be dried and erased easily, without leaving dry erase marker residue due to the non-porous nature of the outer layer, which provides a greaseproof, multi-indicia acceptable surface 10. Static cling polysheets are a known alternative to the dry erase board that accepts only limited dry erase marking or water soluble marking. Current white boards are limited to the indicia they can receive due to staining or adherence problems. Crayon for example cannot be utilized to write on a static cling polysheet or dry erase “white board.” Static cling polysheets are very limited in acceptable range of indicia. The apparatus can be made with an outer layer that accepts dry erase marker and many other types of indicia and that is cleanable without residue that clings to most surfaces with dry-erase marker. The apparatus can include a marking receptive surface distinct from known magnetic whiteboards that can only use water-soluble or dry erase markers. The outer layer 10 of a unit 16, 18 of the apparatus can accept a varied range of indicia including pen, ink, grease-pencil, as well as crayon or other indicia and is capable of being cleaned with a manual rub, or other cleaning means. Time based marking on the outer layer 10 is foreseen. In the preferred embodiment, the flexible design of the apparatus would also allow a unit 16, 18 to be directly attached to a metal surface such as a round support pole.

Each unit can be used as an advertising or promotional product. Ad runs can be changed at any time of the day due to the marking receptive surface area of the apparatus 10. For example, a coupon can be printed on the washable marking receptive surface with an incentive i.e. “10% off” in the morning, rubbed off the apparatus, “50% off” marked on the apparatus at mid day, later rubbed off and “70% off” written on the marking receptive surface of the apparatus by the evening.

Another embodiment using only one unit of the apparatus is as a message center that can be magnetically adhered to a ferrous surface, such as a refrigerator door. One unit of the apparatus is utilized, but more than one unit can be placed next to each other to increase the available writing surface.

As shown in FIG. 3, the apparatus can be utilized as a tab where the magnetic attraction of a first unit 16 of the disclosed apparatus adheres to a second unit 18 of the apparatus. The apparatus can be positioned to indicate a desired position at a page's edge by positioning each unit 16, 18 of the disclosed apparatus as shown in FIG. 2 on the opposite side of a substantially planar surface such as a page. Yet the units 16, 18 of the apparatus are easily detached and repositioned manually. Varied colors, and shapes of each unit 16, 18 of the disclosed apparatus are possible to enhance the indicative qualities of the apparatus.

The compact shape, along with the ability to reposition each unit of the disclosed apparatus in the interior of a page or at a page's edge, allows the apparatus to serve as a position/location pointer, such as to a picture in the middle of a magazine page. The apparatus may be moved for easy readjustment to new areas of a page that a user would like to mark by simply manually repositioning each unit 16, 18 to the desired location.

A plurality of apparatus units can be placed side by side to increase available writing surface as needed. The writing surface 10 can be increased simply by placing units 16, 18 of the apparatus adjacent to each other.

A plurality of apparatus units may be stored conveniently in space limited areas, for example, by hanging a stack of apparatus units 16, 18 on any ferrous surface. For example, apparatus units can be placed on an office's steel reinforced desk wall or by stacking multiple apparatus units in a school locker utilizing a steel locker door surface.

The apparatus units 16, 18 can be placed on the portions of pages of, for example, a book without protruding over an edge and yet can be easily located due to its weight and thickness enabling the book to be stored without the disadvantage of a traditional bookmark becoming dislodged, lost or torn or easily physically damaged. The object to which the apparatus adheres can be mobile without losing the apparatus itself. For example, the wind may blow open a book, but the magnetic adherence of the apparatus holds it in place.

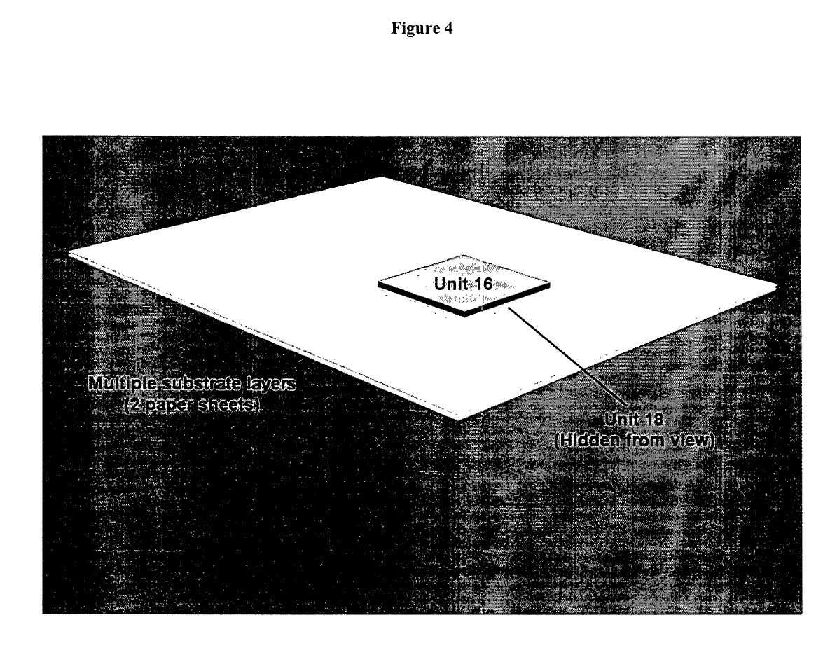

In yet another embodiment, the units 16, 18 of the apparatus shown in FIG. 2 can be utilized as a paper clip even at the interior of a document to bind documents as shown in FIG. 4.

An advantage of the disclosed invention over POST-IT NOTES or “sticky” notes includes the durability and reusability of the magnetic apparatus. The apparatus will not easily fold up or crumble in a book's pages. Furthermore, reusability of the apparatus reduces environmental waste generated from disposable paper notepads, tabs, indicators, paperclips, binders, etc. Furthermore, POST-IT NOTES may bleed onto and discolor an underlying surface, such as a newspaper. However, the adherent quality of the disclosed apparatus will not similarly damage the object to which it is adhered and will not suffer a loss in adherence. For example, the apparatus will not mark surfaces or lift correctable ink from a surface to which it is adhered. Similarly, the apparatus will not physically affect a page as a paper clip may. The apparatus, due to the magnetic adherent force, can be utilized safely with newspapers and is excellent for archival purposes, without damage caused by stickiness. An advantage of the invention over POST-IT NOTES is that in a preferred embodiment, 100% of the outer layers of the apparatus has marking receptive properties, whereas with POST IT NOTES, the glue on a portion of one side makes it difficult to write on the adhesive portion.

The apparatus can be placed under water without physical damage to it. Indicia can be written on the outer surface 10, of the apparatus, which can then be brought underwater. The apparatus can maintain and receive indicia underwater with, for example, a grease pencil's markings. The apparatus maintains adherence in zero gravity environments and is resistant to high humidity.

Each unit of the apparatus may be supplied as a kit, for example, with a magnetic layer 12 that has an adhesive layer attached thereto, with or without a removable backing, and an outer layer that is not initially bonded to the magnetic layer, that may have marking receptive properties. The kit user can simply print on the separately offered outer layer and affix it to the adhesive side of the magnetic layer, using such means as hand pressure or rolling. The outer layer in the kit can be thin enough to be used in a laser or ink jet printer or copier. A kit that contains both the magnetic layer and the outer layer will allow a user to separately insert the outer layer into any printer device and, if desired, print in normal or reverse fashion thereon. If the user has reverse printed on the outer layer, and has then attached the side of the outer layer containing the reverse printing to the magnetic layer, the indicia will be sealed, and thus, will not be affected by moisture, abrasion or other external factors.

Although the invention has been described in connection with preferred and alternate embodiments, other alternatives, modifications and variations may be apparent to those skilled in the art and is therefore intended to embrace all such alternatives, modifications and variations as fall within the spirit and scope of the appended claims:

What is claimed is:

1. A magnetic unit, comprising:
a first magnetic layer;
a second layer having an outer marking receptive surface and an inner reverse-printed surface, the inner surface being adapted to be disposed on the first magnetic layer;
an adhesive disposed between the first magnetic layer and the inner surface of the second layer for binding the layers together.

2. The magnetic unit of claim 1, wherein the second layer is a transparent film.

3. The magnetic unit of claim 1, wherein the first magnetic layer is flexible.

4. The magnetic unit of claim 1, wherein the first magnetic layer include first and second sides, the adhesive is disposed between the first side of the first magnetic layer and the inner surface of the second layer, and wherein the unit further comprises a third layer having an outer marking receptive surface and an inner reverse-printed surface, the inner surface being adapted to be disposed on the first magnetic layer, and an adhesive disposed between the second side of the first magnetic layer and the inner surface of the third layer for binding the layers together.
